(19) United States
(12) Patent Application Publication
(10) Pub. No.: US 2011/0249238 A1
(43) Pub. Date: Oct. 13, 2011

(54) PROJECTION SYSTEM FOR SIMULTANEOUSLY OUTPUTTING IMAGE LIGHT SOURCE WITH DIFFERENT POLARIZATIONS AND METHOD OF USING THE SAME

(75) Inventor: LIU-LIANG LIAO, TAICHUNG CITY (TW)

(73) Assignee: JASPER DISPLAY CORP., HSINCHU (TW)

(21) Appl. No.: 12/860,090

(22) Filed: Aug. 20, 2010

(30) Foreign Application Priority Data
Apr. 9, 2010 (TW) 99111079

(51) Int. Cl. G03B 21/14

(52) U.S. Cl. 353/20

(57) ABSTRACT

A projection system for simultaneously outputting image light source with different polarizations includes a polarizing beam splitting module, an image display module and an image projecting module. The polarizing beam splitting module has a first polarizing beam splitting element for receiving light source, a second polarizing beam splitting element, a third polarizing beam splitting element and a fourth polarizing beam splitting element. The image display module has a first reflective image display panel disposed beside the second polarizing beam splitting element and a second reflective image display panel disposed beside the third polarizing beam splitting element. The image projecting module has at least one projection lens disposed beside the fourth polarizing beam splitting element.

### BACKGROUND OF THE INVENTION

1. Field of the Invention

The present invention relates to a projection system and a method of using the same, and more particularly, to a projection system for simultaneously outputting image light source with different polarizations and a method of using the same.

2. Description of Related Art

Due to the development of optical and projection display technology, digital projection devices with a high number of dots per inch and pixels are often used for briefings, meetings, conferences or trainings. They have also become an important apparatus for family entertainment. Such potential consumers look for a lightweight digital projection apparatuses with high image quality and brightness, all at, of course, a reasonable price.

A projector is an apparatus for projecting images onto a large size screen by optical projection. A projector can be substantially classified into four types, CRT projector, liquid crystal display (LCD) projector, digital light processing (DLP) projector, and liquid crystal on silicon (LCOS) projector, depending on which light valve is adopted. The LCD projector is a transmission projector for its perviousness to light, and LCOS, DLP projectors are reflection projectors because they form images relying on light reflection.

The LCOS projector and the LCD projector are based on similar principles, but the LCOS projector modulates light signals emitted from a light source to a screen by an LCOS panel. In fabricating the LCOS panel, CMOS wafer is adopted as a circuit substrate and a reflection layer. Following that, a liquid crystal layer is coated and packed with a glass panel. Since a reflection structure is adopted in the LCOS projector, light signals emitted from the light source do not pass through the LCOS panel. As a result, the LCOS projector is a reflection projector. On the contrary, in an LCD projector, the light source is mounted behind the LCD panel, and light signals pass through the LCD panel. Therefore, the LCD projector is a transmission projector.

In the prior art, two projectors are arranged to respectively provides S polarization beam and P polarization in order to generate 3D image. However, not only the cost of the prior art is increased due to the usage of the two projectors at the same time, but also a large space is occupied by the two projectors.

### SUMMARY OF THE INVENTION

One particular aspect of the present invention is to provide a projection system for simultaneously outputting image light source with different polarizations and a method of using the same without using two projectors at the same time.

In order to achieve the above-mentioned aspects, the present invention provides a projection system for simultaneously outputting image light source with different polarizations, including: a polarizing beam splitting module, an image display module and an image projecting module. The polarizing beam splitting module has a first polarizing beam splitting element for receiving light source, a second polarizing beam splitting element, a third polarizing beam splitting element and a fourth polarizing beam splitting element. The image display module has a first reflective image display panel disposed beside the second polarizing beam splitting element and a second reflective image display panel disposed beside the third polarizing beam splitting element. The image projecting module has at least one projection lens disposed beside the fourth polarizing beam splitting element.

In order to achieve the above-mentioned aspects, the present invention provides a method of using a projection system for simultaneously outputting image light source with different polarizations, including the steps of: providing a polarizing beam splitting module that has a first polarizing beam splitting element for receiving light source, a second polarizing beam splitting element, a third polarizing beam splitting element and a fourth polarizing beam splitting element; using the first polarizing beam splitting element to divide the light source into a first light source with S polarization beam and a second light source with P polarization beam; using the second polarizing beam splitting element and the first reflective image display panel in sequence to reflect the first light source with S polarization beam in order to transform the first light source with S polarization beam into a first image light source with P polarization beam, wherein the first image light source with P polarization beam passes through the second polarizing beam splitting element and the fourth polarizing beam splitting element in sequence in order to project to the at least one projection lens; letting the second light source with P polarization beam pass through the third polarizing beam splitting element and using the second reflective image display panel to reflect the second light source with P polarization beam in order to transform the second light source with P polarization beam into a second image light source with S polarization beam, wherein the second image light source with S polarization beam is reflected by the third polarizing beam splitting element and the fourth polarizing beam splitting element in sequence in order to project to the at least one projection lens; and letting the first image light source with P polarization beam and the second image light source with S polarization beam pass through the at least one projection lens in order to project onto a surface.

In order to achieve the above-mentioned aspects, the present invention provides a projection system for simultaneously outputting image light source with different polarizations, including: a polarizing beam splitting module, an image display module and an image projecting module. The polarizing beam splitting module has a single X prism for receiving light source. The image display module has a first reflective image display panel and a second reflective image display panel. The image projecting module has at least one projection lens. The first reflective image display panel is disposed beside a first side of the single X prism, the second reflective image display panel and the at least one projection lens are disposed beside a second side of the single X prism, and the first side and the second side are two opposite sides of the single X prism.

Therefore, because the first image light source with P polarization beam and the second image light source with S polarization beam are projected from the at least one projection lens onto the surface of the object, a user can look at the surface of the object to receive 3D image by using a 3D glasses that can receive S polarization beam and P polarization beam at the same time (for example a left lens and a right lens of the 3D glasses used for respectively receiving S polarization beam and P polarization beam).

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are provided solely for reference and illustration, without any intention that they be used for limiting the present invention.

### BRIEF DESCRIPTION OF THE DRAWINGS

FIG. 1 is a schematic view of the projection system for simultaneously outputting image light source with different polarizations according to the first embodiment of the present invention;

FIG. 2 is a schematic view of the projection system for simultaneously outputting image light source with different polarizations according to the second embodiment of the present invention;

FIG. 3 is a flowchart of the method of using the projection system of the first embodiment and the second embodiment of the present invention;

FIG. 4 is a schematic view of the projection system for simultaneously outputting image light source with different polarizations according to the third embodiment of the present invention; and

FIG. 5 is a flowchart of the method of using the projection system of the third embodiment of the present invention.

### DETAILED DESCRIPTION OF THE PREFERRED EMBODIMENTS

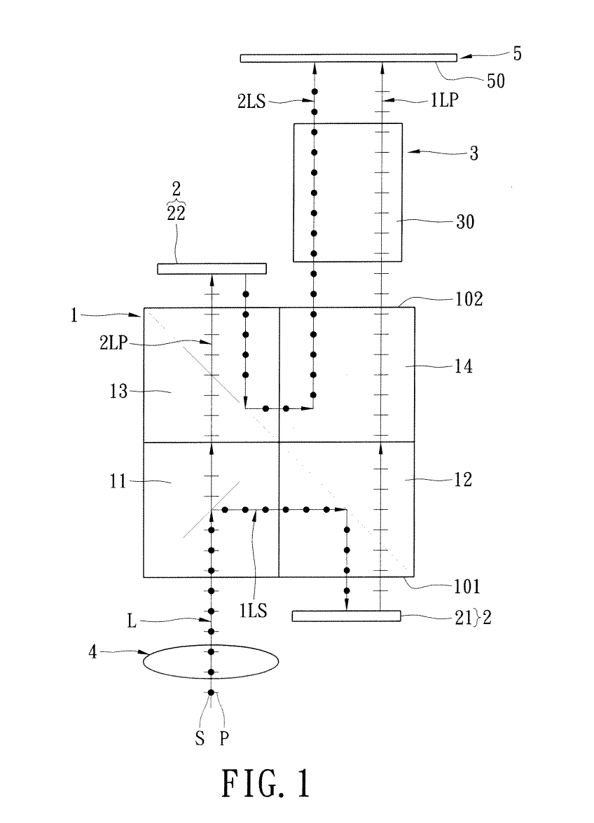

Referring to FIG. 1, the first embodiment of the present invention provides a projection system for simultaneously outputting image light source with different polarizations, including: a polarizing beam splitting module 1, an image display module 2 and an image projecting module 3.

The polarizing beam splitting module 1 has a first polarizing beam splitting element 11 for receiving light source L, a second polarizing beam splitting element 12, a third polarizing beam splitting element 13 and a fourth polarizing beam splitting element 14, and the first polarizing beam splitting element 11, the second polarizing beam splitting element 12, the third polarizing beam splitting element 13 and the fourth polarizing beam splitting element 14 all may be polarization beam splitters (PBS). The light source L is composed of S polarization beam (shown as the label of “” and the number of “S” in FIG. 1) and P polarization beam (shown as the label of “-” and the number of “P” in FIG. 1). For example, the first polarizing beam splitting element 11, the second polarizing beam splitting element 12, the third polarizing beam splitting element 13 and the fourth polarizing beam splitting element 14 are tightly combined together, and thus the polarizing beam splitting module 1 is a single piece construction or an integral construction.

In other words, one side of the second polarizing beam splitting element 12 and one side of the first polarizing beam splitting element 11 are tightly connected with each other, one side of the third polarizing beam splitting element 13 and another side of the first polarizing beam splitting element 11 are tightly connected with each other, one side of the fourth polarizing beam splitting element 14 and another side of the second polarizing beam splitting element 12 are tightly connected with each other, and another side of the fourth polarizing beam splitting element 14 and another side of the third polarizing beam splitting element 13 are tightly connected with each other. Hence, the polarizing beam splitting elements are tightly connected with each other, and thereby the polarizing beam splitting module 1 is manufactured as a single piece construction or an integral construction.

Moreover, the image display module 2 has a first reflective image display panel 21 disposed beside the second polarizing beam splitting element 12 (beside the first side 101 of the polarizing beam splitting module 1) and a second reflective image display panel 22 disposed beside the third polarizing beam splitting element 13 (beside the second side 102 of the polarizing beam splitting module 1). For example, both the first reflective image display panel 21 and the second reflective image display panel 22 are LCOS panels. Furthermore, the image projecting module 3 has at least one projection lens 30 disposed beside the fourth polarizing beam splitting element 14 (beside the second side 102 of the polarizing beam splitting module 1). In other words, the second reflective image display panel 22 and the at least one projection lens 30 are disposed beside the second side 102 of the polarizing beam splitting module 1, and the second reflective image display panel 22 and the at least one projection lens 30 are adjacent to each other by a predetermined distance.

When the light source L passes through the lens 4 to project onto the first polarizing beam splitting element 11 of the polarizing beam splitting module 1, the light source L can be divided into a first light source 1LS with S polarization beam (shown as the label of “” and the number of “S” in FIG. 1) and a second light source 2LP with P polarization beam (shown as the label of “-” and the number of “P” in FIG. 1) by the first polarizing beam splitting element 11.

Moreover, the second polarizing beam splitting element 12 and the first reflective image display panel 21 sequentially reflect the first light source 1LS with S polarization in order to transform the first light source 1LS with S polarization into a first image light source 1LP with P polarization beam, the first image light source 1LP with P polarization beam is projected to the at least one projection lens 30 through the second polarizing beam splitting element 12 and the fourth polarizing beam splitting element 14 in sequence.

Furthermore, the second light source 2LP with P polarization beam passes through the third polarizing beam splitting element 13 and is reflected by the second reflective image display panel 22 in order to transform the second light source 2LP with P polarization beam into a second image light source 2LS with S polarization beam, the third polarizing beam splitting element 13 and the fourth polarizing beam splitting element 14 sequentially reflect the second image light source 2LS with S polarization beam in order to project the second image light source 2LS with S polarization beam to the at least one projection lens 30. Finally, the first image light source 1LP with P polarization beam and the second image light source 2LS with S polarization beam are projected onto a surface 50 of an object 5 (such as an image display surface of a screen for a projector) through the at least one projection lens 30.

Therefore, because the first image light source 1LP with P polarization beam and the second image light source 2LS with S polarization beam are projected from the at least one projection lens 30 onto the surface 50 of the object 5, a user can look at the surface 50 of the object 5 to receive 3D image by using a 3D glasses that can receive S polarization beam and P polarization beam at the same time (for example a left lens and a right lens of the 3D glasses used for respectively receiving S polarization beam and P polarization beam).

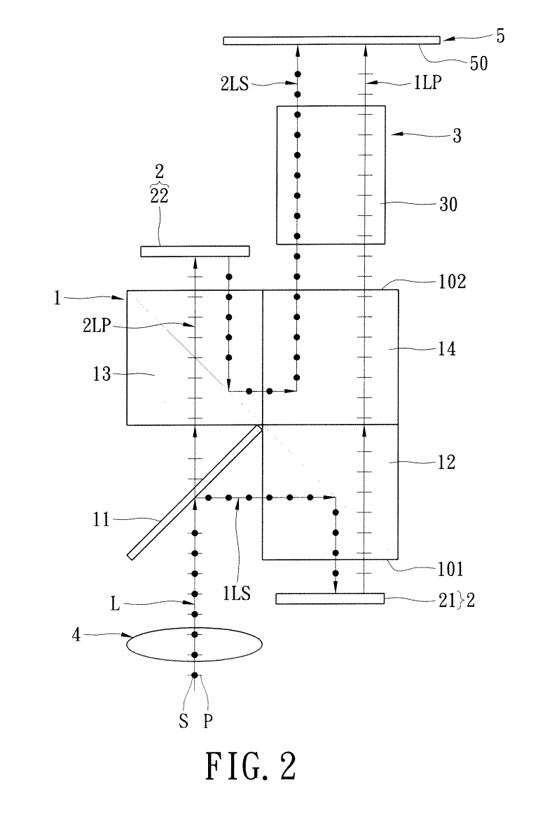

Referring to FIG. 2, the second embodiment of the present invention provides a projection system for simultaneously outputting image light source with different polarizations, including: a polarizing beam splitting module 1, an image display module 2 and an image projecting module 3. The difference between the second embodiment and the first embodiment is that: in the second embodiment, the first polarizing beam splitting element 11 may be a single plate polarization beam splitter disposed beside one side of the second polarizing beam splitting element 12 and one side of the third polarizing beam splitting element 13, and thus only the second polarizing beam splitting element 12, the third polarizing beam splitting element 13 and the fourth polarizing beam splitting element 14 are tightly combined together to form a single piece optical element. In other words, one side of the fourth polarizing beam splitting element 14 and another side of the second polarizing beam splitting element 12 are tightly connected with each other, and another side of the fourth polarizing beam splitting element 14 and another side of the third polarizing beam splitting element 13 are tightly connected with each other, and thereby the second polarizing beam splitting element 12, the third polarizing beam splitting element 13 and the fourth polarizing beam splitting element 14 are tightly combined together to form the single piece optical element. In addition, the brightness generated by the second embodiment is larger than that of the first embodiment due to the usage of the single plate polarization beam splitter in the second embodiment.

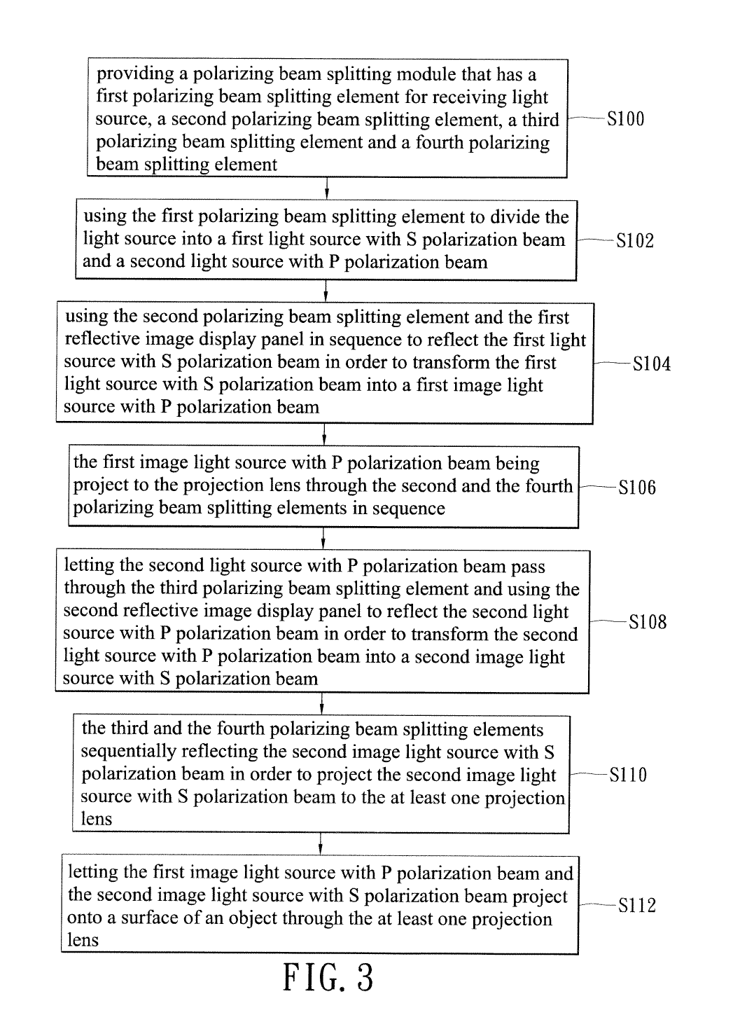

Referring to FIG. 3, in the first embodiment and the second embodiment, the present invention provides a method of using a projection system for simultaneously outputting image light source with different polarizations, including the steps of:

The step S100 is that: providing a polarizing beam splitting module 1 that has a first polarizing beam splitting element 11 for receiving light source L, a second polarizing beam splitting element 12, a third polarizing beam splitting element 13 and a fourth polarizing beam splitting element 14.

The step S102 is that: using the first polarizing beam splitting element 11 to divide the light source L into a first light source 1LS with S polarization beam and a second light source 2LP with P polarization beam.

The step S104 is that: using the second polarizing beam splitting element 12 and the first reflective image display panel 21 in sequence to reflect the first light source 1LS with S polarization beam in order to transform the first light source 1LS with S polarization beam into a first image light source 1LP with P polarization beam.

The step S106 is that: the first image light source 1LP with P polarization beam being project to the at least one projection lens 30 through the second polarizing beam splitting element 12 and the fourth polarizing beam splitting element 14 in sequence.

The step S108 is that: letting the second light source 2LP with P polarization beam pass through the third polarizing beam splitting element 13 and using the second reflective image display panel 22 to reflect the second light source 2LP with P polarization beam in order to transform the second light source 2LP with P polarization beam into a second image light source 2LS with S polarization beam.

The step S110 is that: the third polarizing beam splitting element 13 and the fourth polarizing beam splitting element 14 sequentially reflecting the second image light source 2LS with S polarization beam in order to project the second image light source 2LS with S polarization beam to the at least one projection lens 30.

The step S112 is that: letting the first image light source 1LP with P polarization beam and the second image light source 2LS with S polarization beam project onto a surface 50 of an object 5 through the at least one projection lens 30.

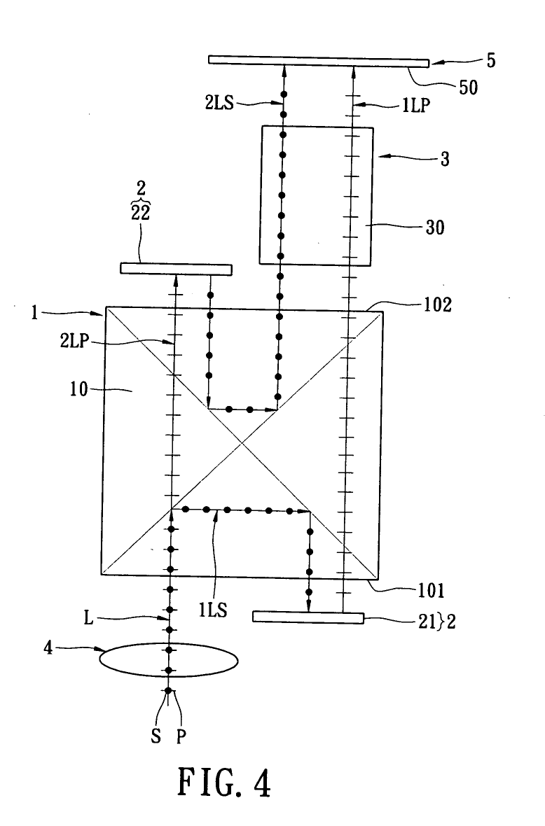

Referring to FIG. 4, the third embodiment of the present invention provides a projection system for simultaneously outputting image light source with different polarizations, including: a polarizing beam splitting module 1, an image display module 2 and an image projecting module 3.

The polarizing beam splitting module 1 has a single X prism 10 for receiving light source L, and the single X prism 10 has a polarizing beam splitting function. The light source L is composed of S polarization beam (shown as the label of “” and the number of “S” in FIG. 4) and P polarization beam (shown as the label of “-” and the number of “P” in FIG. 4). The image display module 2 has a first reflective image display panel 21 and a second reflective image display panel 22, and both the first reflective image display panel 21 and the second reflective image display panel 22 may be LCOS panels. The image projecting module 3 has at least one projection lens 30. In addition, the first reflective image display panel 21 is disposed beside a first side 101 of the single X prism 10, the second reflective image display panel 22 and the at least one projection lens 30 are disposed beside a second side 102 of the single X prism 10, and the first side 101 and the second side 102 are two opposite sides of the single X prism 10.

When the light source L passes through the lens 4 to project onto the single X prism 10 of the polarizing beam splitting module 1, the light source L can be divided into a first light source 1LS with S polarization beam (shown as the label of “” and the number of “S” in FIG. 4) and a second light source 2LP with P polarization beam (shown as the label of “-” and the number of “P” in FIG. 4) by the single X prism 10.

Moreover, the single X prism 10 and the first reflective image display panel 21 sequentially reflect the first light source 1LS with S polarization beam in order to transform the first light source 1LS with S polarization beam into a first image light source 1LP with P polarization beam, and the first image light source 1LP with P polarization beam is projected to the at least one projection lens 30 through the single X prism 10. In addition, the second light source 2LP with P polarization beam passes through the single X prism 10 and is reflected by the second reflective image display panel 22 in order to transform the second light source 2LP with P polarization beam into a second image light source 2LS with S polarization beam, and the single X prism 10 reflects the second image light source 2LS with S polarization beam in order to project the second image light source 2LS with S polarization beam to the at least one projection lens 30. Finally, the first image light source 1LP with P polarization beam and the second image light source 2LS with S polarization beam are projected onto a surface 50 of an object 5 (such as an image display surface of a screen for a projector) through the at least one projection lens 30.

Therefore, because the first image light source 1LP with P polarization beam and the second image light source 2LS with S polarization beam are projected from the at least one projection lens 30 onto the surface 50 of the object 5, a user can look at the surface 50 of the object 5 to receive 3D image by using a 3D glasses that can receive S polarization beam and P polarization beam at the same time (for example a left lens and a right lens of the 3D glasses used for respectively receiving S polarization beam and P polarization beam).

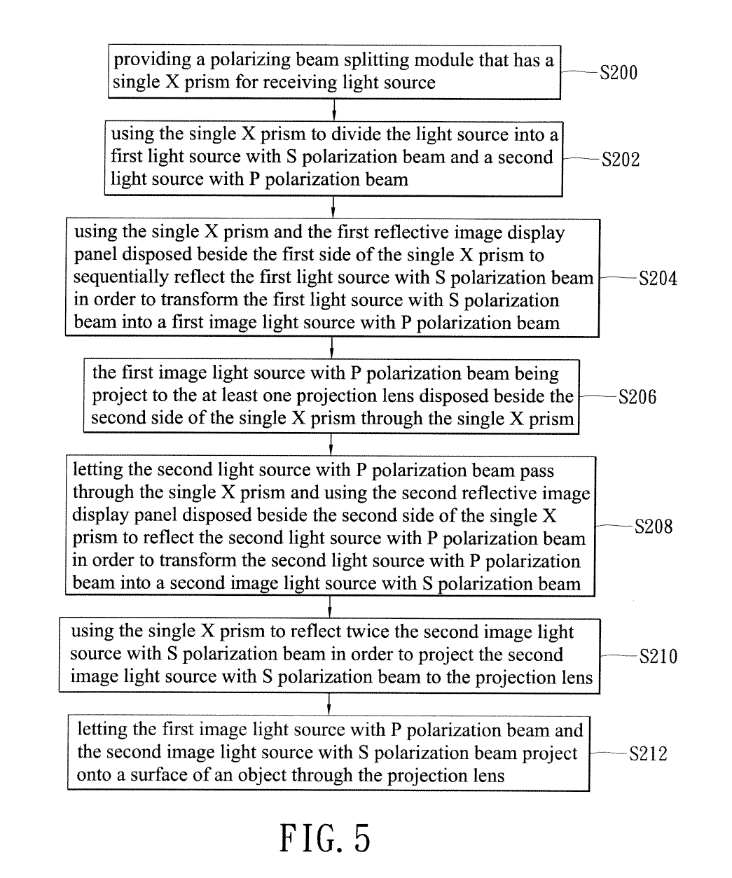

Referring to FIG. 5, in the third embodiment and the second embodiment, the present invention provides a method of using a projection system for simultaneously outputting image light source with different polarizations, including the steps of:

The step S200 is that: providing a polarizing beam splitting module 1 that has a single X prism 10 for receiving light source L.

The step S202 is that: using the single X prism 10 to divide the light source L into a first light source 1LS with S polarization beam and a second light source 2LP with P polarization beam.

The step S204 is that: using the single X prism 10 and the first reflective image display panel 21 disposed beside the first side of the single X prism 10 to sequentially reflect the first light source 1LS with S polarization beam in order to transform the first light source 1LS with S polarization beam into a first image light source 1LP with P polarization beam.

The step S206 is that: the first image light source 1LP with P polarization beam being project to the at least one projection lens 30 disposed beside the second side 102 of the single X prism 10 through the single X prism 10.

The step S208 is that: letting the second light source 2LP with P polarization beam pass through the single X prism 10 and using the second reflective image display panel 22 disposed beside the second side 102 of the single X prism 10 to reflect the second light source 2LP with P polarization beam in order to transform the second light source 2LP with P polarization beam into a second image light source 2LS with S polarization beam. In addition, the first side 101 and the second side 102 are two opposite sides of the single X prism 10.

The step S210 is that: using the single X prism 10 to reflect twice the second image light source 2LS with S polarization beam in order to project the second image light source 2LS with S polarization beam to the at least one projection lens 30.

The step S212 is that: letting the first image light source 1LP with P polarization beam and the second image light source 2LS with S polarization beam project onto a surface 50 of an object 5 through the at least one projection lens 30.

In conclusion, because the first image light source with P polarization beam and the second image light source with S polarization beam are projected from the at least one projection lens onto the surface of the object, a user can look at the surface of the object to receive 3D image by using a 3D glasses that can receive S polarization beam and P polarization beam at the same time (for example a left lens and a right lens of the 3D glasses used for respectively receiving S polarization beam and P polarization beam).

The above-mentioned descriptions merely represent solely the preferred embodiments of the present invention, without any intention or ability to limit the scope of the present invention which is fully described only within the following claims. Various equivalent changes, alterations or modifications based on the claims of present invention are all, consequently, viewed as being embraced by the scope of the present invention.

What is claimed is:

1. A projection system for simultaneously outputting image light source with different polarizations, comprising:
a polarizing beam splitting module having a first polarizing beam splitting element for receiving light source, a second polarizing beam splitting element, a third polarizing beam splitting element and a fourth polarizing beam splitting element;
an image display module having a first reflective image display panel disposed beside the second polarizing beam splitting element and a second reflective image display panel disposed beside the third polarizing beam splitting element; and
an image projecting module having at least one projection lens disposed beside the fourth polarizing beam splitting element.

2. The projection system as claimed in claim 1, wherein the light source is divided into a first light source with S polarization beam and a second light source with P polarization beam by the first polarizing beam splitting element.

3. The projection system as claimed in claim 2, wherein the second polarizing beam splitting element and the first reflective image display panel sequentially reflect the first light source with S polarization in order to transform the first light source with S polarization into a first image light source with P polarization beam, the first image light source with P polarization beam is projected to the at least one projection lens through the second polarizing beam splitting element and the fourth polarizing beam splitting element in sequence, the second light source with P polarization beam passes through the third polarizing beam splitting element and is reflected by the second reflective image display panel in order to transform the second light source with P polarization beam into a second image light source with S polarization beam, the third polarizing beam splitting element and the fourth polarizing beam splitting element sequentially reflect the second image light source with S polarization beam in order to project the second image light source with S polarization beam to the at least one projection lens.

4. The projection system as claimed in claim 1, wherein the first polarizing beam splitting element, the second polarizing beam splitting element, the third polarizing beam splitting element and the fourth polarizing beam splitting element are tightly combined together.

5. The projection system as claimed in claim 4, wherein one side of the second polarizing beam splitting element and one side of the first polarizing beam splitting element are tightly connected with each other, one side of the third polarizing beam splitting element and another side of the first polarizing beam splitting element are tightly connected with each other, one side of the fourth polarizing beam splitting element and another side of the second polarizing beam splitting element are tightly connected with each other, and another side of the fourth polarizing beam splitting element and another side of the third polarizing beam splitting element are tightly connected with each other.

6. The projection system as claimed in claim 1, wherein the second polarizing beam splitting element, the third polarizing beam splitting element and the fourth polarizing beam splitting element are tightly combined together.

7. The projection system as claimed in claim 6, wherein the first polarizing beam splitting element is a single plate polarization beam splitter disposed beside one side of the second polarizing beam splitting element and one side of the third polarizing beam splitting element, one side of the fourth polarizing beam splitting element and another side of the second polarizing beam splitting element are tightly connected with each other, and another side of the fourth polarizing beam splitting element and another side, of the third polarizing beam splitting element are tightly connected with each other.

8. The projection system as claimed in claim 1, wherein both the first reflective image display panel and the second reflective image display panel are LCOS panels.

9. A method of using a projection system for simultaneously outputting image light source with different polarizations, comprising the steps of:
providing a polarizing beam splitting module that has a first polarizing beam splitting element for receiving light source, a second polarizing beam splitting element, a third polarizing beam splitting element and a fourth polarizing beam splitting element;
using the first polarizing beam splitting element to divide the light source into a first light source with S polarization beam and a second light source with P polarization beam;
using the second polarizing beam splitting element and the first reflective image display panel to sequentially reflect the first light source with S polarization beam in order to transform the first light source with S polarization beam into a first image light source with P polarization beam, wherein the first image light source with P polarization beam is projected to the at least one projection lens through the second polarizing beam splitting element and the fourth polarizing beam splitting element in sequence;
letting the second light source with P polarization beam pass through the third polarizing beam splitting element and using the second reflective image display panel to reflect the second light source with P polarization beam in order to transform the second light source with P polarization beam into a second image light source with S polarization beam, wherein the third polarizing beam splitting element and the fourth polarizing beam splitting element sequentially reflect the second image light source with S polarization beam in order to project the second image light source with S polarization beam to the at least one projection lens; and
letting the first image light source with P polarization beam and the second image light source with S polarization beam project onto a surface through the at least one projection lens.

10. The method as claimed in claim 9, wherein the first polarizing beam splitting element, the second polarizing beam splitting element, the third polarizing beam splitting element and the fourth polarizing beam splitting element are tightly combined together.

11. The method as claimed in claim 10, wherein one side of the second polarizing beam splitting element and one side of the first polarizing beam splitting element are tightly connected with each other, one side of the third polarizing beam splitting element and another side of the first polarizing beam splitting element are tightly connected with each other, one side of the fourth polarizing beam splitting element and another side of the second polarizing beam splitting element are tightly connected with each other, and another side of the fourth polarizing beam splitting element and another side of the third polarizing beam splitting element are tightly connected with each other.

12. The method as claimed in claim 9, wherein the second polarizing beam splitting element, the third polarizing beam splitting element and the fourth polarizing beam splitting element are tightly combined together.

13. The method as claimed in claim 12, wherein the first polarizing beam splitting element is a single plate polarization beam splitter disposed beside one side of the second polarizing beam splitting element and one side of the third polarizing beam splitting element, one side of the fourth polarizing beam splitting element and another side of the second polarizing beam splitting element are tightly connected with each other, and another side of the fourth polarizing beam splitting element and another side of the third polarizing beam splitting element are tightly connected with each other.

14. The method as claimed in claim 9, wherein both the first reflective image display panel and the second reflective image display panel are LCOS panels.

15. A projection system for simultaneously outputting image light source with different polarizations, comprising:
a polarizing beam splitting module having a single X prism for receiving light source;
an image display module having a first reflective image display panel and a second reflective image display panel; and
an image projecting module having at least one projection lens;
wherein the first reflective image display panel is disposed beside a first side of the single X prism, the second reflective image display panel and the at least one projection lens are disposed beside a second side of the single X prism, and the first side and the second side are two opposite sides of the single X prism.

16. The projection system as claimed in claim 15, wherein the light source is divided into a first light source with S polarization beam and a second light source with P polarization beam by the single X prism.

17. The projection system as claimed in claim 16, wherein the single X prism and the first reflective image display panel sequentially reflect the first light source with S polarization beam in order to transform the first light source with S polarization beam into a first image light source with P polarization beam, the first image light source with P polarization beam is projected to the at least one projection lens through the single X prism, the second light source with P polarization beam passes through the single X prism and is reflected by the second reflective image display panel in order to transform the second light source with P polarization beam into a second image light source with S polarization beam, the single X prism reflects the second image light source with S polarization beam in order to project the second image light source with S polarization beam to the at least one projection lens.

18. The projection system as claimed in claim 15, wherein both the first reflective image display panel and the second reflective image display panel are LCOS panels.
